(19) United States
(12) Patent Application Publication
(10) Pub. No.: US 2026/0187261 A1
(43) Pub. Date: Jul. 2, 2026

(54) NEAR FIELD COMMUNICATION (NFC)-BASED SESSION SHARING ACROSS MULTIPLE DEVICES

(71) Applicants: American Express Travel Related Services Company, Inc., New York, NY (US); American Express Services Europe Limited, London (GB)

(72) Inventors: Manik Biswas, Burgess Hill (GB); Mukund Shankar SimhaRaghu, Glendale, AZ (US)

(21) Appl. No.: 19/004,921

(22) Filed: Dec. 30, 2024

(51) Int. Cl. G06F 21/60; H04W 4/80

(52) U.S. Cl. CPC G06F 21/606; H04W 4/80

(57) ABSTRACT

Disclosed are various embodiments for securely sharing a web or application session across multiple devices or systems. When a session is to be transferred to another device, the device associated with the active session can package all session related data and assets and transmit the packaged session data to another device via near-field communication (NFC). The receiving device is then able to use the packaged session data and assets to seamlessly continue the session journey.

### BACKGROUND

An interactive session relates to a period of time in which a user interacts with a website or application. A session is established when a user opens up a website or application on his or her client device and the session ends when the user leaves the website or closes the browser or application. A session between a server and the client device can be identified using a unique identifier. During a session, the user may interact with one or more pages or views associated with the website or application.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a sequence diagram illustrating examples of functionality in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIG. 5 is a flowchart illustrating one example of functionality implemented as portions of an application executed in a computing environment in the network environment of FIG. 2 according to various embodiments of the present disclosure.

FIG. 6 is a flowchart illustrating one example of functionality implemented as portions of an application executed in a computing environment in the network environment of FIG. 2 according to various embodiments of the present disclosure.

### DETAILED DESCRIPTION

Disclosed are various approaches for securely sharing a web or application session across multiple devices or systems. Sometimes an interactive session may need to be broken into multiple segments where each segment is executed or performed on different devices. For example, if within a particular web session, biometric authentication is required and the device associated with the web session is not a biometric enabled device, the web session may need to be transferred to a biometric enabled device for authentication. In another example, a user may be editing a document on one device, but wants to finish editing the document on another device. Such a system requires a means to share the status and steps to the next device to continue to the journey. However, traditional implementations for device sharing include an overhead of reestablishing the security session and associated credential on the next device. The present disclosure provides a seamless way to achieve the session transfer with all associated and/or required credentials or assets securely from one device to another.

According to various examples, the present disclosure relates to securely packaging all session related data and assets and transferring the packaged session data to another device via near-field communication (NFC). The receiving device can use the packaged session data and assets to seamlessly continue the session. In various examples, a client agent on a transferring device is configured to work with or otherwise be integrated within a web-based application (e.g., browser) or other type of application to accumulate all session related elements and assets (e.g., session identifier, session status, session keys, session context, session interaction history, etc.). In various examples, when a device transfer is requested, the client agent can prepare one or more session tags (e.g., ISO7816 TAG) that include the session data and initialize an integrated or connected NFC device. The user can then be prompted to tap a receiving device against the NFC device to establish a NFC peer-to-peer connection. The client agent on the transferring device can then pass data associated with the one or more session tags to the receiving device. In some examples, the receiving device can send a transfer request token to the transferring device that can be verified by the transferring device prior to the transferring device sending the session data to the receiving device. The receiving device uses the obtained session data to resume the web-session that was previously occurring on the transferring device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

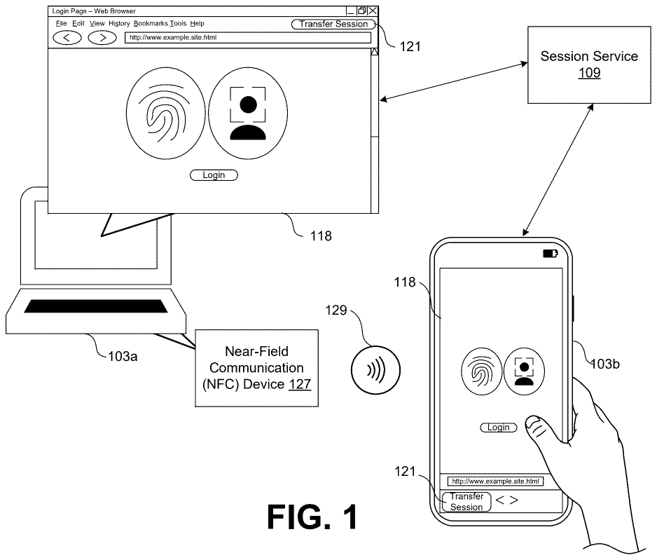

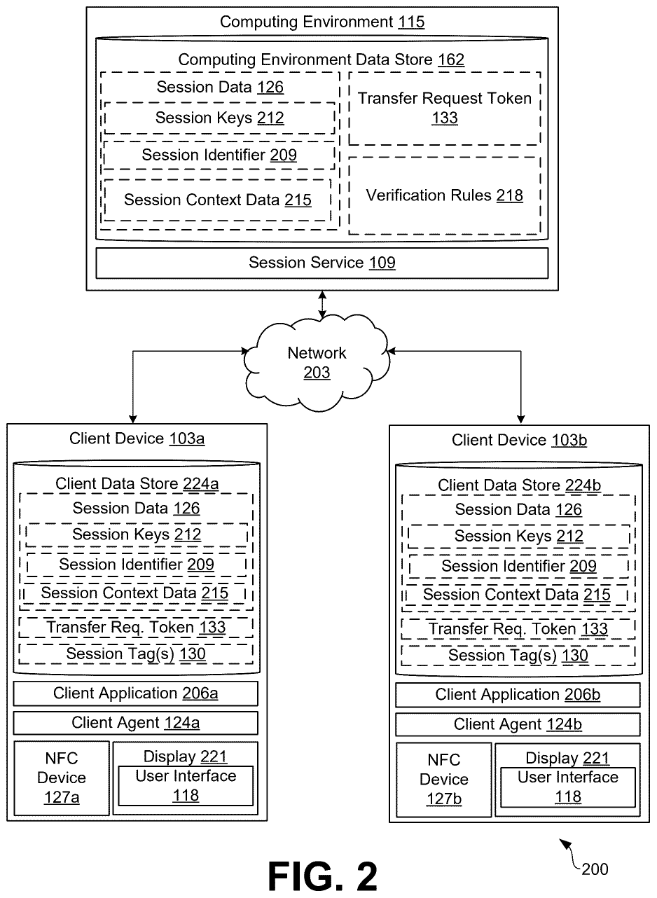

FIG. 1 provides an example scenario 100 in which a web session is transferred from a client device 103a (e.g., laptop computer) to another client device 103b (e.g., mobile device). In this example, a web session is established between the client device 103a and a session service 109 hosted within a computing environment 115 (FIG. 2). In particular, a user interface 118 served up by the session service 109 is rendered by the client device 103a to allow a user to interact with the session service 109 via the user interface 118 during a given web session.

In this example, the web session requires a biometric authentication to proceed with the web session journey. Assume that the client device 103a is either not biometric enabled or that the user prefers to perform biometric authentications on his or her mobile device (e.g., client device 103b). In this situation, the user can click on a transfer component 121 to indicate a request to transfer the web session that is active on the client device 103a (e.g., transferor) to the client device 103b (e.g., transferee). In response to a selection of the transfer component 121, a client agent 124a (FIG. 2) of the client device 103a can accumulate session data 126 (FIG. 2) associated with the active session (e.g., session identifier, session keys, authentication tokens, session interaction history, session status, session context, etc.) and generate one or more NFC session tags 130 (e.g., ISO7816 tag) that include the session data 126. The client agent 124a can also initialize a NFC device 127 that is integrated within or otherwise in communication with the client device 103a. When the NFC device 127 is initialized, a prompt can be generated and presented to the user via a user interface 118 on the client device 103a instructing the user to tap the client device 103b (e.g., receiving client) to the NFC device 127 associated with the client device 103a (e.g., transferring client). When the client device 103b taps the NFC device 127 or is placed within the appropriate proximity to the NFC device 127, a NFC peer to peer connection 129 is established and the client device 103a can transfer the session data 126 in the form of NFC session tags 130 to the client device 103b.

In various examples, the client device 103b can continue the interactive session with the session service 109 by presenting the session identifier and other relevant session data obtained from the client device 103a in a request to the session service 109. In this example, the user interface 118 that was previously rendered on the client device 103a can be rendered on the client device 103b to allow the user to use the client device 103b to complete the biometric authentication. In a situation in which the user wishes to return the session to the client device 103a or send to another client device 103, the user can select the transfer component 121 on the client device 103b. As such, a client agent 124b (FIG. 2) on the client device 103b can package the updated session data 126 in the form of a session tag 130 and request the NFC transfer of the session data 126 with the client device 103a or other client device 103.

In some examples, the session service 109 can verify that the device transfer is permitted or otherwise legitimate before proceeding to continue the session with the client device 103b. For example, upon establishing a NFC peer to peer connection 129 between the client device 103a and the client device 103b, the client device 103b can transmit a transfer request token 133 (FIG. 2) to the client device 103a in exchange for the session data. The client device 103a can transmit the transfer request token 133 to the session service 109 while notifying the session service 109 of the potential session transfer. In various examples, the transfer request token 133 can include device data, authentication data, and/or other types of data that the session service 109 can use to identify and verify the client device 103b when the client device 103b requests a continuation of the session. Prior to continuing the session with the client device 103b, the session service 109 can compare data from the transfer request token 133 with the session data 126 included in a session request from the client device 103b to determine whether it is a legitimate transfer. Once the session service 109 verifies the transfer, the session service 109 can authorize the continuation of the session and resume the journey with the client device 103b.

It should be noted that although FIG. 1 illustrates a web session transfer between the session service 109 and the client device 103a and the client device 103b, in some examples, a session transfer can correspond to an application-based session transfer and can occur between the client device 103a and the client device 103b without any third parties (e.g., computing environment 115). For example, a user editing a document on the client device 103a may want to continue editing the document on a client device 103b. In this example, an application session is established with a client application executing on the client device 103a. Similarly to the web-session transfer, when a user indicates he or she wants to transfer the session through the selection of a transfer component 121 on a user interface 118 associated with the client application, the client agent 124a can package all session data related to the application session and prompt the user to tap the client device 103b on the NFC device 127 to establish a NFC peer-to-peer connection 129. In some examples, the client device 103b can transmit a transfer request token 133 that is signed by a private key associated with the client device 103b and the client device 103a can verify the signature prior to sending the packaged session data to the client device 103b via the NFC peer-to-peer connection 129. Accordingly, the client device 103b can use the received session data 126 to resume the application-based session on the client device 103b.

With reference to FIG. 2, shown is a network environment 200 according to various embodiments. The network environment 200 can include a computing environment 115, a client device 103a, and a client device 103b, which can be in data communication with each other via a network 203.

The network 203 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 203 can also include a combination of two or more networks 203. Examples of networks 203 can include the Internet, intranets, extranets, virtual private networks (VPNs), and similar networks.

The computing environment 115 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 115 can employ a plurality of computing devices that can be arranged in one or more server banks or computer banks or other arrangements. Such computing devices can be located in a single installation or can be distributed among many different geographical locations. For example, the computing environment 115 can include a plurality of computing devices that together can include a hosted computing resource, a grid computing resource or any other distributed computing arrangement. In some cases, the computing environment 115 can correspond to an elastic computing resource where the allotted capacity of processing, network, storage, or other computing-related resources can vary over time.

Various applications or other functionality can be executed in the computing environment 115. The components executed on the computing environment 115 include a session service 109, and other applications, services, processes, systems, engines, or functionality not discussed in detail herein.

The session service 109 can interact with a client application 206 (e.g., 206a, 206b) executed on a client device 103 to serve up content (e.g., web pages, user interfaces 118) to the client device 103 via one or more requests or responses (e.g., HTTP/HTTPs requests or responses) over a period of time in the form of a web session. For example, the session service 109 can correspond to a web server that can store and deliver web content to a client device 103. In various examples, the session service 109 can initiate a web session with a client device 103 in response to a request from the client device 103 to access a website or application associated with the session service 109. When initiating a web session, the session service 109 can generate session data 126 that corresponds to a given session. The session data 126 can be stored in the computing environment data store 162 and can be updated throughout the duration of a given web session. The session data 126 can include a session identifier 209, one or more session keys 212, session context data 215, user data (e.g., username, authentication details, etc.), and/or other data that is relevant during a user's interaction. In various examples, the session service 109 can provide the session identifier 209, session keys 212, and/or other relevant session data in the form of a session payload to the client device 103 associated with the given session.

The session identifier 209 is a unique identifier that is associated with the given session. The session identifier 209 can be used to associate the user's requests (e.g., requests from the client device 103) with the given session to provide a personalized experience for the user interacting with the session service 109 via the client device 103. A session key 212 comprises a randomly generated symmetric key for encrypting and decrypting data during a communication session. The session context data 215 can include session state data, session interaction history data (e.g., page views, page clicks, etc.), form data, and/or other types of data that correspond to a particular web session between the session service 109 and the client device 103.

In various examples, the session service 109 can authorize a web session transfer between a client device 103a and a client device 103b. For example, assume the session service 109 has an active web session with the client device 103a and that the user of the client device 103 wishes to transfer the active web session from the client device 103a to the client device 106. In various examples, the client device 103a can send a notification of the transfer with a transfer request token 133 to the session service 109 notifying the session service 109 of the transfer request and identifying the client device 103b. In various examples, the transfer request token 133 can comprise JSON web token or other type of token that can be used to represent the client device 103b and/or any corresponding permissions associated with the client device 103b and/or the transfer. In various examples, the transfer request token 133 can be generated and signed by the client device 103b and then provided to the client device 103a via NFC. In various examples, the client device 103a can verify the signature of the transfer request token 133 before notifying the session service 109 of the transfer.

The session service 109 can further obtain a continue session request from the client device 103b. In some examples, the session service 109 can receive a request from the client device 103b for content associated with the active web session. In particular, the request can include the session identifier 209, session keys 212 and/or other relevant session data 126 that can be used to identify the session that was previously established between the session service 109 and the client device 103a. In response to receiving the request, the session service 109 can compare the received session data 126 with the notification and/or properties within transfer request token 133 received from the client device 103a to determine that the web session transfer between client devices 103 is legitimate. For example, the session service 109 can associate the transfer request token 133 with the session identifier 209 when received from the client device 103a. Since the transfer request token 133 is used to identify the client device 103b, the session service 109 can determine that the transfer is legitimate when the session service 109 receives a session request from the client device 103b that is associated with the transfer request token 133 and includes the session identifier 209 of the session that was established between the client device 103a and the session service 109. Upon authorizing the legitimacy of the transfer, the session service 109 can continue the web session with the client device 103b.

Also, various data is stored in a computing environment data store 162 that is accessible to the computing environment 115. The computing environment data store 162 can be representative of a plurality of data stores 162, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the computing environment data store 162 is associated with the operation of the various applications or functional entities described below. This data can include session data 126, the transfer request token 133, verification rules 218, and potentially other data.

The session data 126 can represent data associated with a web session established between a client device 103 and the session service 109. The session data 126 can include a session identifier 209, one or more session keys 212, session context data 215, user data (e.g., username, authentication details, etc.), and/or other data that is relevant during a user's interaction. The session identifier 209 is a unique identifier that is associated with the given session. The session identifier 209 can be used to associate the user's requests (e.g., requests from the client device 103) with the given session to provide a personalized experience for the user interacting with the session service 109 via the client device 103. A session key 212 comprises a randomly generated symmetric key for encrypting and decrypting data during a communication session. The session context data 215 can include session state data, session interaction history data (e.g., page views, page clicks, etc.), form data, and/or other types of data that correspond to a particular web session between the session service 109 and the client device 103. During the duration of the session, the session context data 215 can be updated to reflect the current status of the session.

The transfer request token 133 can comprise JSON web token or other type of token that can be used to represent a transfer receiving client (e.g., a client device 103b) and/or any corresponding permissions associated with the receiving client or transfer. In various examples, the transfer request token 133 can be generated and signed by the receiving client (e.g., client device 103b) and then provided to the transferring client (e.g., client device 103a) via NFC. The session service 109 can receive the transfer request token 133 from the transferring client in a notification indicating the pending session transfer to the receiving client. The session service 109 stores the transfer request token 133 in the computing environment data store 162 and uses the transfer request token 133 to authorize a continuation of a web session with the receiving client (e.g., the client device 103b).

The verification rules 218 include rules, models, and/or configuration data for the various algorithms or approaches employed by the session service 109 for authorizing a transfer of an active session from client device 103a to client device 103b. In various examples, the session service 109 can employ the verification rules 218 when determining whether to authorize a continuation of active session request from a client device 103b. In particular, the verification rules 218 can define what data should be compared between the transfer request token 133 and transfer notification received from the client device 103a and the session data 126 included in the continuation of an active session request received from the client device 103b. The verification rules 218 can further define the steps to take if the continuation of an active session request is denied. For example, the verification rules 218 can define who to contact when the request is denied, whether to terminate the session with the client device 103a, and/or other action.

A client device 103 (e.g., client device 103a and client device 103b) is representative of a plurality of client devices that can be coupled to the network 203. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays 221, such as liquid crystal displays (LCDs), gas plasma-based flat panel displays, organic light emitting diode (OLED) displays, electrophoretic ink (“E-ink”) displays, projectors, or other types of display devices. In some instances, the display 221 can be a component of the client device 103 or can be connected to the client device 103 through a wired or wireless connection.

In various examples, the client device 103 can include a NFC device 127 (e.g., 127a, 127b) which can either be integrated within the client device 103 and/or in data communication with the client device 103. The NFC device 127 can include a device that uses NFC protocols to establish NFC peer-to-peer connections 129 for exchanging data wirelessly via an NFC protocol to another devices with similar or like capability. In various examples, the client device 103a (e.g., transferor) can initialize the NFC device 127 with a generated session tag 130 including the session data 126 of a session being transferred to the client device 103b (e.g., transferee). When the client device 103b is placed in the appropriate proximity to client device 103a, the NFC device 127a of the client device 103a and the NFC device 127b of the client device 103 can establish a NFC peer-to-peer connection 129 to allow the client device 103b to receive the session tag 130 and/or session data 126 included in the session tag 130. Accordingly, the NFC device 127 can include a NFC reader that allows the NFC device 127 to obtain data being transferred from another NFC device 127.

The client device 103 can be configured to execute various applications such as a client application 206 (e.g., 206a, 206b), a client agent 124 (e.g., 124a, 124b), or other applications. The client application 206 can be executed in a client device 103 to access network content served up by the computing environment 115 or other servers, thereby rendering a user interface 118 on the display 221. To this end, the client application 206 can include a browser, a dedicated application, or other executable, and the user interface 118 can include a network page, an application screen, or other user mechanism for obtaining user input. The client device 103 can be configured to execute applications beyond the client application 206 such as email applications, social networking applications, word processors, spreadsheets, or other applications.

The client agent 124 can capture and store session data 126 associated with an active session. For example, the client agent 124 can accumulate all relevant and necessary data from an active session including the session keys 212, session identifier 209, session context data 215, authentication data (e.g., username/password, authentication tokens, etc.) and/or other data that is relevant for a given session. Although illustrated as separate applications in FIG. 2, in some examples, the client agent 124 is integrated within the client application 206. For example, the client agent 124 can correspond to a plug-in or other type of component that adds functionality to the client application 206.

When the client device 103 is a transferring device (e.g., client device 103a), the client agent 124 can determine that the session is to be transferred based on an interaction with a transfer component 121 that is included on a user interface 118 associated with an active session. For example, the client agent 124 can detect the selection of the transfer component 121 to determine that a transfer is to occur. In response to determining that a transfer is to occur, the client agent 124 can package the session data 126 into the form of one or more session tags 130 that can be presented and transferred to a receiving device (e.g., client device 103b) through an NFC peer-to-peer connection 129. In various examples, client agent 124 can generate the session tags 130 in compliance with ISO7816 and/or other NFC compliant standard. In various examples, the client agent 124 can initialize the NFC device 127 with the generated session tags 130 and prepare the NFC device 127 for an NFC peer-to-peer connection 129. In various examples, the client agent 124 can generate a prompt that is rendered on the transferring client device 103a to notify the user that the transferring client device 103a is ready to transfer the session data 126 to the receiving client device 103b via a tap of the receiving client device 103b on the NFC device 127 of the transferring client device 103a.

In various examples, the client agent 124 can obtain a transfer request token 133 from the NFC device 127 in response to the NFC device 127 obtaining the transfer request token 133 from the client device 103 receiving the session data 126. In various examples, the transfer request token 133 can comprise JSON web token or other type of token that can be used to represent the client device 103b and/or any corresponding permissions associated with the client device 103b and/or the transfer. In various examples, the transfer request token 133 can be generated and signed by the client agent 124 of the client device 103b receiving the session data 126, and then provided to the client agent 124 of the client device 103a transferring the session data 126 via NFC. In various examples, the client agent 124 can generate and send a notification of the transfer with a transfer request token 133 to the session service 109 notifying the session service 109 of the transfer request and identifying the receiving device (e.g., client device 103b). In various examples, the client agent 124 can verify the signature of the transfer request token 133 prior to notifying the session service 109 of the transfer.

When the client device 103 is a receiving device (e.g., client device 103b), the client agent 124 can generate and sign a transfer request token 133 that can be transmitted to the NFC device 127b of client device 103b. In various examples, the transfer request token 133 can comprise JSON web token or other type of token that can be used to represent the client device 103b and/or any corresponding permissions associated with the client device 103b and/or the transfer. In various examples, the transfer request token 133 can be generated and signed by the client device 103b and then provided to the NFC device 127b of the client device 103b.

The client agent 124 can further obtain the session data 126 obtained from the NFC device 127b of the client device 103b via the NFC peer-to-peer connection 128 with the client device 103a. The client agent 124 can provide the session data 126 to the client application 206 which can be used to generate a continuation of transfer request that is sent to the session service 109 to resume the session.

The client data store 224 (e.g., 224a, 224b) represents mass storage or memory in which the client device 103 can store information. The client data store 224 can include session data 126, a transfer request token 133, one or more session tags 130, and/or other data The session data 126 can represent data associated with a web session established between a client device 103 and the session service 109. and/or an application session of the client application 206. The session data 126 can include a session identifier 209, one or more session keys 212, session context data 215, user data (e.g., username, authentication details, etc.), and/or other data that is relevant during a user's interaction. The session identifier 209 is a unique identifier that is associated with the given session. The session identifier 209 can be used to associate the user's requests (e.g., requests from the client device 103) with the given session to provide a personalized experience for the user interacting with the session service 109 via the client device 103. A session key 212 comprises a randomly generated symmetric key for encrypting and decrypting data during a communication session. The session context data 215 can include session state data, session interaction history data (e.g., page views, page clicks, etc.), form data, and/or other types of data that correspond to a particular web session between the session service 109 and the client device 103. During the duration of the session, the session context data 215 can be updated to reflect the current status of the session.

The transfer request token 133 can comprise JSON web token or other type of token that can be used to represent a transfer receiving client (e.g., a client device 103b) and/or any corresponding permissions associated with the receiving client or transfer. In various examples, the transfer request token 133 can be generated and signed by the receiving client (e.g., client device 103b) and then provided to the transferring client (e.g., client device 103a) via NFC.

A session tag 130 can comprise an ISO7816 compliant and/or other NFC compliant tag that is generated to represent the session data 126 to be transferred. The session data 126 can include the session keys 212 and corresponding session payload data including the session identifier 209, session context data 215, authentication data, and/or other types of relevant data.

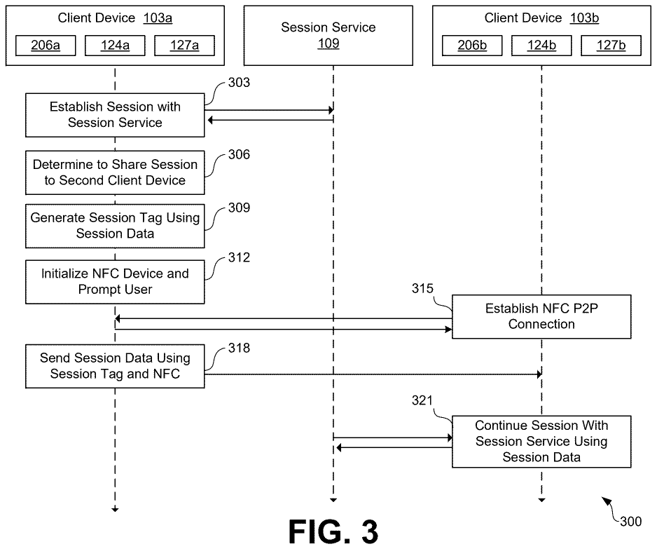

Referring next to FIG. 3, shown is a sequence diagram 300 depicting the interactions between the various components of the network environment 200 according to various embodiments of the present disclosure. The sequence diagram of FIG. 3 is intended to illustrate how the client device 103a transfers a web session established between client device 103a and the session service 109 to the client device 103b. As an alternative, the sequence diagram 300 of FIG. 3 can be viewed as depicting an example of elements of a method implemented within the network environment 200. In the example of FIG. 3, the client device 103a represents a transferring device and the client device 103b represents a receiving device. However, it should be noted that in some examples, the client device 103a can be a receiving device and client device 103b can be a transferring device as both devices have capabilities to be the transferor and the transferee.

Beginning with block 303, the client device 103a, via a client application 206a, can establish a web session with the session service 109. For example, a web session can be established between the client application 206a and the session service 109 when a user requests via interactions with the client application 206a to access a website or application associated with the session service 109. When initiating a web session, the session service 109 can generate session data 126 that corresponds to a given session. The session data 126 can include a session identifier 209, one or more session keys 212, session context data 215, user data (e.g., username, authentication details, etc.), and/or other data that is relevant during a user's interaction. In various examples, the session service 109 can provide the session identifier 209, session keys 212, and/or other relevant session data in the form of a session payload to the client application 206a associated with the given session. As the client application 206a interacts with the session service 109, the client application 206a will include the session identifier 209 and other corresponding payload data in a request to the session service 109. The session service 109 will receive the requests from the client application 206a and provide responses to the requests. In some examples, session service 109 can update the session data 126 (e.g., session context data 215) throughout the duration of a given web session. During the session, the client agent 124a can capture and store the session data 126 associated with the active session.

At step 306, the client device 103a, via the client agent 124a or the client application 206a, can determine that the user interacting with the client device 103a would like to transfer the established web session with the session service 109 to another device. In some examples, the client agent 124a or the client application 206a can determine a transfer session request in response to a user selecting the transfer component 121 included on the user interface 118 of the client application 206a. For example, a user interacting with the client application 206a can select the transfer component 121 to initiate a transfer of the session to another client device 103. In other examples, the client application 206a or the client agent 124a can automatically determine based at least in part on the session context data 215 that a device transfer is required. For example, if the session context 215 indicates an action that is required during the session that is not compatible with the client device 103a, the client application 206a or the client agent 124a can determine that a session transfer needs to occur.

At block 309, the client agent 124a can generate one or more session tags 130 using the session data 126 captured by the client agent 124a. In response to determining that a transfer is to occur, the client agent 124 can package the session data 126 into the form of one or more session tags 130 that can be presented and transferred to a receiving device (e.g., client device 103b) through an NFC peer-to-peer connection 129. In various examples, client agent 124 can generate the session tags 130 in compliance with ISO7816 and/or other NFC compliant standard.

At block 312, the client agent 124a can initialize the NFC device 127a with the generated session tags 130 and prepare the NFC device 127a for an NFC peer-to-peer connection 129. In various examples, the client agent 124a can generate a prompt that is rendered on the transferring client device 103a to notify the user that the transferring client device 103a is ready to transfer the session data 126 to the receiving client device 103b via a tap of the receiving client device 103b on the NFC device 127 of the transferring client device 103a.

At block 315, the NFC device 127a of the client device 103a and the NFC device 127a of the client device 103b can establish an NFC peer-to-peer connection 129 using NFC protocols. In various examples, when the client device 103b is placed in the appropriate proximity to client device 103a or otherwise taps the NFC device 127a, the NFC device 127a of the client device 103a and the NFC device 127b of the client device 103 can establish an NFC peer-to-peer connection 129.

At block 318, the NFC device 127a can send the session data 126 in the form of the one or more session tags 130 to the NFC device 127b of the client device 103b. The session tags 130 can include the session keys 212 and any appropriate session payload data (e.g., session identifier 209, session context data 215, user data, etc.). In some examples, the NFC device 127a can obtain a transfer request token 133 from the client device 103b. The NFC device 127a of the client device 103a and the NFC device 127b of the client device 103b can exchange the session data 126 with the transfer request token 133 via the NFC peer-to-peer connection 129. In other examples, the NFC device 127a can receive the transfer request token 133 from the client device 103b and provides the session tags 130 to the client device 103b in response to the transfer request token 133 being verified.

At block 321, the client application 206b of the client device 103b can continue the session with session service 109. For example, the client application 206b can use the session data 126 obtained from the client device 103a to generate a session request to the session service 109. The session request can include the session identifier 209 and any payload data can be encrypted using the session key 212 associated with the original session. In some examples, the client application 206b can send a continuation of session request to the session service 109 and the session service 109 can authorize the continuation of the session in response to a verification process to verify that the device transfer is legitimate and that the client device 103b is permitted to continue the session originally started by the client device 103a. In response to authorizing the continuation of the session, the session service 109 and the client application 206b can resume the session. Thereafter, this portion of the process proceeds to completion.

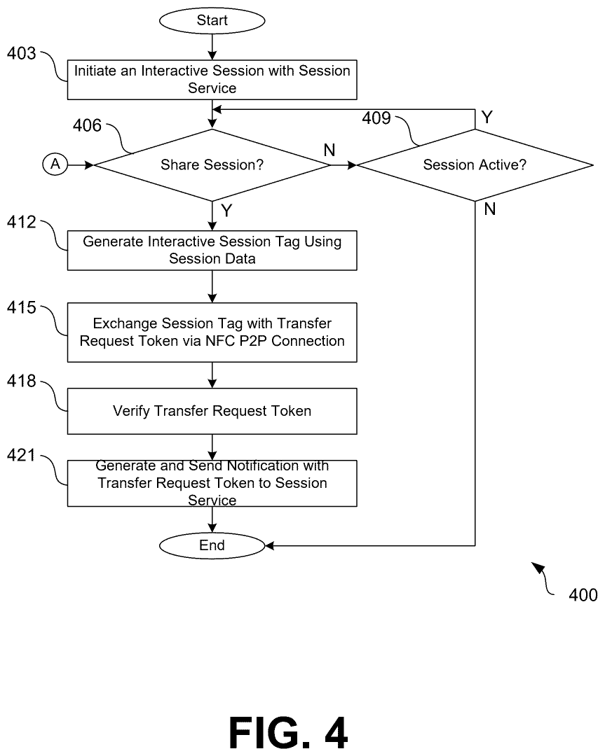

Referring next to FIG. 4, shown is a flowchart 400 that provides one example of the operation of portions of the client agent 124 and the client application 206. As previously noted, the functionality of the client agent 124 can be integrated within the functionality of the client application 206. The flowchart of FIG. 4 provides merely an example of the many different types of functional arrangements that can be employed to implement the operation of the depicted portions of the client agent 124 and the client application 206. As an alternative, the flowchart of FIG. 4 can be viewed as depicting an example of elements of a method implemented within the network environment 200. FIG. 4 relates to the functionality of the client agent 124 and the client application 206 on a client device 103 when the client device 103 transfers an active session with a session service 109 to another client device 103.

Beginning with block 403, the client application 206 can initiate an interactive session with a session service 109. For example, a web session can be initiated with the session service 109 when a user requests via interactions with the client application 206 to access a website or application associated with the session service 109. When initiating a web session, the session service 109 can generate session data 126 that corresponds to a given session. The session data 126 can include a session identifier 209, one or more session keys 212, session context data 215, user data (e.g., username, authentication details, etc.), and/or other data that is relevant during a user's interaction. In various examples, the client application 206 can receive the session identifier 209, session keys 212, and/or other relevant session data in the form of a session payload. As the client application 206 interacts with the session service 109, the client application 206 can include the session identifier 209 and other corresponding payload data in a request to the session service 109. The session service 109 will receive the requests from the client application 206 and provide responses to the requests. During the session, the client agent 124a can capture and store the session data 126 associated with the active session.

At block 406, the client application 206 and/or the client agent 124 can determine whether the session is to be shared or otherwise transferred. In some examples, the client agent 124 or the client application 206 can determine a transfer session request in response to detecting a user selecting the transfer component 121 included on the user interface 118 of the client application 206. For example, a user interacting with the client application 206 can select the transfer component 121 to initiate a transfer of the session to another client device 103. In other examples, the client application 206 or the client agent 124 can automatically determine based at least in part on the session context data 215 that a device transfer is required. For example, if the session context data 215 indicates an action that is required during the session that is not compatible with the client device 103, the client application 206 or the client agent 124 can determine that a session transfer needs to occur. If the session is not to be shared or transferred, the process proceeds to block 409. Otherwise, the process proceeds to block 412.

At block 409, the client application 206 and/or client agent 124 can determine if the session is still active. For example, if the user has requested to interact with another application or website that is not associated with the session service 109, the session can be determined to be inactive. Additionally, if the user closes the client application 206, the session can be considered inactive. If the session remains active, the process returns to block 406. Otherwise, the process proceeds to completion.

At block 412, the client agent 124 can generate one or more session tags 130 using the session data 126 captured by the client agent 124. In response to determining that a transfer is to occur, the client agent 124 can package the session data 126 into the form of one or more session tags 130 that can be presented and transferred to a receiving device (e.g., client device 103b) through an NFC peer-to-peer connection 129. In various examples, client agent 124 can generate the session tags 130 in compliance with ISO7816 and/or other NFC compliant standard.

At block 415, the client agent 124 and/or the client application 206 can exchange the session tag 130 with a transfer request token 133 via a NFC peer-to-peer connection 129. In various example, the client agent 124 can initialize the NFC device 127 with the generated session tags 130 and prepare the NFC device 127 for an NFC peer-to-peer connection 129. In various examples, the client agent 124 can generate a prompt that is rendered on the transferring client device 103 to notify the user that the transferring client device 103 is ready to transfer the session data 126 to the receiving client device 103 via a tap of the receiving client device 103b on the NFC device 127 of the transferring client device 103a. In various examples, when a receiving client device 103b is placed in the appropriate proximity to a transferring client device 103a or otherwise taps the NFC device 127a of the client device 103a a NFC peer-to-peer connection 129 can be established and the transferring client device 103 exchange the session tag 130 with the session data 126 with the transfer request token 133 via the NFC peer-to-peer connection 129. Accordingly, the client agent 124 of the transferring client device 103a can receive the transfer request token 133 of the receiving client device 103b from the NFC device 127 and the receiving client device 103b can receive the session tag 130 with the session data 126 from the transferring client device 103a.

At block 418, the client agent 124 and/or the client application 206 can verify the transfer request token 133 that is received from the receiving client device 103b. For example, the transfer request token 133 can be digitally signed by the receiving client device 103b or other trusted entity. The client agent 124 and/or client application 206 can use a public key associated with eh client device 103b or other trusted entity to verify the digital signature of the transfer request token 133.

At block 421, the client agent 124 and/or the client application 206 can generate and send a notification with the transfer request token 133 and session identifier 209 to the session service 109. The notification can be generated to notify the session service 109 of the session transfer and includes the session identifier 209 to allow the session service 109 to identify the session of interest and store the transfer request token 133 in association with the session of interest. In various examples, the client agent 124 and/or the client application 206 can send the notification to the session service 109 in communications over the network 203. Thereafter, this portion of the process proceeds to completion.

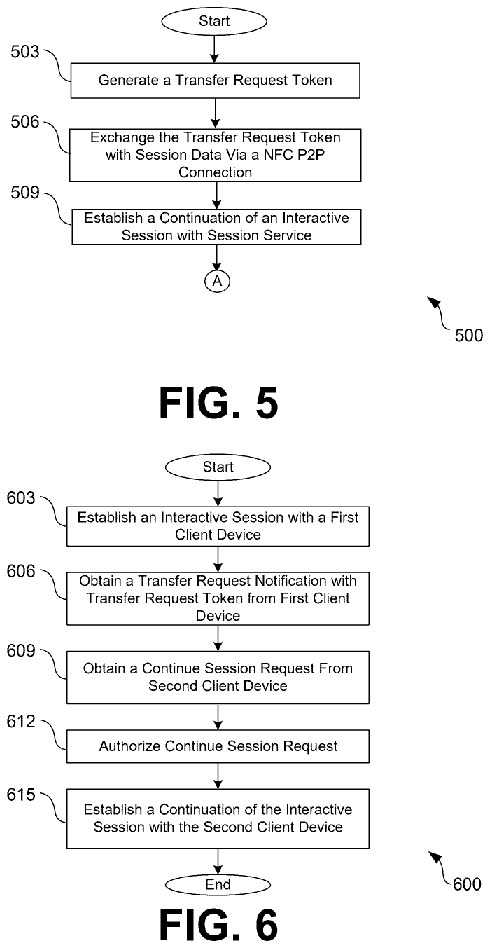

Moving on to FIG. 5, shown is a flowchart 500 that provides one example of the operation of portions of the client agent 124 and the client application 206. As previously noted, the functionality of the client agent 124 can be integrated within the functionality of the client application 206. The flowchart of FIG. 5 provides merely an example of the many different types of functional arrangements that can be employed to implement the operation of the depicted portions of the client agent 124 and the client application 206. As an alternative, the flowchart of FIG. 5 can be viewed as depicting an example of elements of a method implemented within the network environment 200. FIG. 5 relates to the functionality of the client agent 124 and the client application 206 on a client device 103 when the client device 103 continues an active session with a session service 109 that was established by another client device 103.

Beginning with block 503, the client agent 124 can generate a transfer request token 133. The transfer request token 133 can comprise JSON web token or other type of token that can be used to represent a transfer receiving client (e.g., client device 103b) and/or any corresponding permissions associated with the receiving client or transfer. In various examples, the client agent 124 can use at least one of Rivest-Shamir-Adelman (RSA), digital signature algorithm (DSA), Elliptic Curve Digital Signature algorithm (ECDSA) or another digital signature algorithm to generate the digital signature of transfer request token 133 that can used for verification.

At block 506, the client agent 124 and/or client application 206 can exchange the transfer request token 133 with session data 126 in the form of session tags 130 via NFC peer-to-peer connection 129. A user can place the client device 103 near an NFC device 127 of a transferring client device 103. When the receiving client device 103 is placed in the appropriate proximity to a transferring client device 103 or otherwise taps the NFC device 127 of the client device 103, an NFC peer-to-peer connection 129 can be established allowing the exchange of the session data 126 with the transfer request token 133 via the NFC peer-to-peer connection 129. Accordingly, the client agent 124 can receive the session data 126 in response to the NFC peer-to-peer connection 129.

At block 509, the client application 206 can continue the session with session service 109. For example, the client application 206 can use the obtained session data 126 to generate a session request to the session service 109. The session request can include the session identifier 209 and any payload data can be encrypted using the session key 212 associated with the original session. In some examples, the client application 206 can send a continuation of session request to the session service 109 and the session service 109 authorizes the continuation of the session in response to a verification process to verify that the device transfer is legitimate and that the client application 206 is permitted to continue the session originally started by another client device 103. In response to authorizing the continuation of the session, the session service 109 and the client application 206 can resume the session.

Thereafter, this portion of the process proceeds to block 406 in FIG. 4. FIG. 4 relates to the functionality of the client agent 124 and the client application 206 on a client device 103 when the client device 103 transfers an active session with a session service 109 to another client device 103. In various examples, the user interacting with the receiving client device 103 may want to return the interactive session to original client device 103 or transfer to another client device 103. As such, there can be a chain of transfers and the receiving device 103 can become a transferring client device and/or the transferring client device 103 can become a receiving client device 103.

Moving on to FIG. 6, shown is a flowchart 600 that provides one example of the operation of portions of the session service 109. The flowchart of FIG. 6 provides merely an example of the many different types of functional arrangements that can be employed to implement the operation of the depicted portions of the session service 109. As an alternative, the flowchart of FIG. 6 can be viewed as depicting an example of elements of a method implemented within the network environment 200.

Beginning with block 603, the session service 109 can establish an interactive session with a first client device 103. For example, a web session can be established between the client application 206 and the session service 109 when a user requests via interactions with the client application 206 to access a website or application associated with the session service 109. When initiating a web session, the session service 109 can generate session data 126 that corresponds to a given session. The session data 126 can include a session identifier 209, one or more session keys 212, session context data 215, user data (e.g., username, authentication details, etc.), and/or other data that is relevant during a user's interaction. In various examples, the session service 109 can provide the session identifier 209, session keys 212, and/or other relevant session data in the form of a session payload to the client application 206 associated with the given session. As the client application 206 interacts with the session service 109, the client application 206 can include the session identifier 209 and other corresponding payload data in a request to the session service 109. The session service 109 can receive the requests from the client application 206 and provide responses to the requests. In some examples, session service 109 can update the session data 126 (e.g., session context data 215) throughout the duration of a given web session.

At block 606, the session service 109 can obtain a transfer request notification with a transfer request token 133 from the first client device 103. In some examples, the notification indicates that the active session is to be transferred to a second client device 103. In some examples, the notification includes the session identifier 209 and/or other relevant session data that allows the session service 109 to associate the transfer request token 133 with an active session. In various examples, the transfer request token 133 can comprise JSON web token or other type of token that can be used to represent the second client device 103 (e.g., transferee) and/or any corresponding permissions associated with the second client device 103 and/or the transfer. In various examples, the transfer request token 133 can be generated and signed by second client device 103 (e.g., transferee) and then provided to the first client device 103 via NFC. In various examples, the first client device 103 can verify the signature of the transfer request token 133 sending the notification to the session service 109.

At block 609, the session service 109 can obtain a continue session request from the second client device 103. In some examples, the session service 109 can receive the continue session request from the second client device 103 for content associated with the active web session. In particular, the continue session request can include the session identifier 209, session keys 212 and/or other relevant session data 126 that can be used to identify the session that was previously established between the session service 109 and the first client device 103.

At block 612, the session service 109 can authorize the continue session request. For example, in response to receiving the continue session request, the session service 109 can compare the received session data 126 with the notification and/or properties within transfer request token 133 received from the first client device 103 to determine that the web session transfer between client devices 103 is legitimate. For example, the session service 109 can associate the transfer request token 133 with the session identifier 209 when received from the first client device 103. Since the transfer request token 133 is used to identify the first client device 103, the session service 109 can determine that the transfer is legitimate when the session service 109 receives the continue session request from the second client device 103 that is associated with the transfer request token 133 and includes the session identifier 209 of the session that was established between the first client device 103 and the session service 109. Upon determining the at the continue transfer request is legitimate, the session service 109 can authorize the transfer.

At block 615, the session service 109 can continue the interactive session with the second client device 103. For example, the client application 206 of the second client device 103 can use the session data 126 obtained from the first client device 103 to generate a session request to the session service 109. As the client application 206 of the second client device 103 interacts with the session service 109, the client application 206 will include the session identifier 209 and other corresponding payload data in requests to the session service 109. The session service 109 can receive the requests from the client application 206 and provide responses to the requests. In some examples, session service 109 can update the session data 126 (e.g., session context data 215) throughout the duration of a given web session. Thereafter, this portion of the process proceeds to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 115.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a first client device comprising a processor and a memory;
a first NFC device in data communication with the processor of the first client device; and
machine-readable instructions stored in the memory that, when executed by the processor, cause the first client device to at least:
initiate an interactive session with a session service;
determine that the interactive session with the session service is to be transferred to a second client device;
generate a session tag with session data associated with the interactive session; and
transfer the session tag with the session data to the second client device via a NFC peer-to-peer communication between the first NFC device and a second NFC device associated with the second client device.

2. The system of claim 1, wherein the session data comprises one or more session keys, a session identifier, a session state, or session context data.

3. The system of claim 1, wherein, when executed, the machine-readable instructions further cause the first client device to at least receive a transfer request token from the second client device via the NFC peer-to-peer communication, the transfer request token being digitally signed by the second client device.

4. The system of claim 3, wherein, when executed, the machine-readable instructions further cause the first client device to at least verify the transfer request token based at least in part on a digital signature.

5. The system of claim 3, wherein, when executed, the machine-readable instructions further cause the first client device to at least send the transfer request token to the session service to notify the session service of a transfer of the interactive session from the client device to the client device.

6. The system of claim 1, wherein the interactive session comprises one or more user interactions of a user interacting with a user interface associated with the session service.

7. The system of claim 6, wherein, when executed, the machine-readable instructions further cause the first client device to detect a selection of a transfer component via a user interaction with the user interface, the interactive session with the session service being determined to be transferred to the second client device based at least in part on the selection.

8. The system of claim 1, wherein the session data is generated as an NFC tag for transfer via the NFC peer-to-peer communication.

9. A method, comprising:
establishing, by a first client device, a near field communication (NFC) peer-to-peer connection between the first client device and a second client device;
obtaining, by the first client device, session data from the second client device via the NFC peer-to-peer connection, the session data corresponding to an interactive session between the second client device and a computing device; and
establishing, by the first client device, a continuation of the interactive session with the computing device based at least in part on the session data.

10. The method of claim 9, further comprising:
generating a transfer request token for authorization to accept a transfer of the interactive session between the second client device and the computing device; and
exchanging the transfer request token to the second client device via the NFC peer-to-peer connection.

11. The method of claim 10, wherein establishing the continuation of the interactive session with the computing device further comprises sending a transfer request to establish the continuation of the interactive session to the computing device, the transfer request comprising the transfer request token and the session data, the continuation of the interactive session with the computing device being established in response to the computing device validating the transfer request.

12. The method of claim 9, wherein the session data comprises one or more session keys, a session identifier, a session state, or session context data.

13. The method of claim 9, further comprising:
determining that the interactive session with the computing device is to be transferred to a third client device;
generating second session tag with that interactive session data associated with the interactive session and the continuation of the interactive session; and
sending the second session tag with the second interactive session data to the third client device via a second NFC peer-to-peer connection with a NFC device associated with the third client device.

14. The method of claim 13, further comprising:
receiving a second transfer request token via the second NFC peer-to-peer connection; and
verifying the second transfer request token prior to sending the second session tag to the third client device.

15. A non-transitory, computer-readable medium, comprising machine-readable instructions that, when executed by a processor of a computing device, cause the computing device to at least:
establish an interactive session with a first client device;
obtain a transfer request token from the first client device, the transfer request token being associated with a second client device;
obtain a continue session request from the second client device, the continue session request comprising session data associated with the interactive session with the first client device;
authorize the continue session request based at least in part on the transfer request token and the session data; and
establish a continuation of the interactive session with the second client device.

16. The non-transitory, computer-readable medium of claim 15, wherein the first client device obtains the transfer request token from the second client device via an NFC peer-to-peer communication between the first client device and the second client device.

17. The non-transitory, computer-readable medium of claim 15, wherein the second client device obtains the session data from the first client device via an NFC peer-to-peer communication between the first client device and the second client device.

18. The non-transitory, computer-readable medium of claim 15, wherein obtaining the transfer request token further comprises obtaining a notification from the first client device, the notification indicating a transfer of the interaction session to the second client device, and the notification comprising the transfer request token and a session identifier.

19. The non-transitory, computer-readable medium of claim 18, wherein authorizing the continue session request further comprises comparing the session data with the notification.

20. The non-transitory, computer-readable medium of claim 15, wherein the wherein the session data comprises one or more session keys, a session identifier, a session state, or session context data.
